(19) United States
(12) Patent Application Publication
(10) Pub. No.: US 2007/0264056 A1
(43) Pub. Date: Nov. 15, 2007

(54) Doctor blade with tangential working tip

(76) Inventors: Ronald Willard Baker, Versailles, KY (US); Ligia Aura Bejat, Versailles, KY (US); Michael Craig Leemhuis, Nicholasville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/434,600

(22) Filed: May 15, 2006

(51) Int. Cl. G03G 15/08

(52) U.S. Cl. 399/284

(57) ABSTRACT

A doctor blade for a printer may include a cantilever spring. The free end of the cantilever spring includes a section with a first bend in one direction and a second bend in the opposite direction. Thus, a bump end may be formed which has a surface which is generally tangential to the surface of a developer roll against which the doctor blade is biased.

### BACKGROUND

This invention relates generally to electro-photographic printers that use toner to transfer an image to a medium.

In conventional electrophotographic printing, toner is transferred from a developer roll to a photoconductive surface and eventually to a medium. In order to obtain a good transfer of the image, it is desirable that the toner on a developer roll be applied very evenly. Even application of toner may be facilitated by using a doctor blade that controls the thickness of the toner on the developer roll. As the developer roll rotates, the doctor blade doctors the toner applied thereto and provides a relatively uniform toner coating.

Since the application of the uniform toner coating may be critical to the performance of the printer, there is a continuing need for better doctor blade designs.

### BRIEF DESCRIPTION OF THE DRAWINGS

FIG. 1 is a partial, cross-sectional view of one embodiment of the present invention in a loaded configuration;

FIG. 2 is an exploded depiction of the embodiment of FIG. 1 in a loaded configuration; and

FIG. 3 is a schematic depiction of a printer in accordance with one embodiment of the present invention.

### DETAILED DESCRIPTION

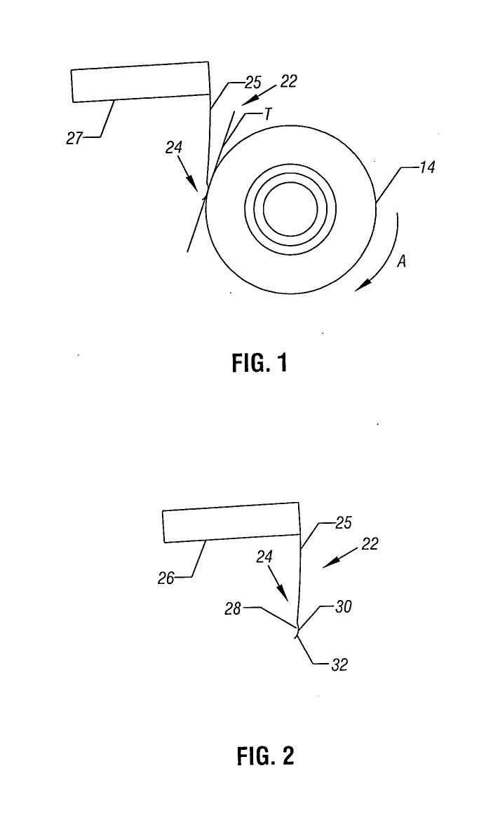

Referring to FIG. 1, a developer roll 14 rotates in the direction indicated by the arrow A. The developer roll 14 may be covered with a layer of toner (not shown). Biased against the surface of the developer roll 14 is a doctor blade 22. In one embodiment of the present invention, the doctor blade 22 is a thin, highly resilient metallic sheet that acts as a cantilevered leaf spring. For example, the doctor blade 22 may be made of stainless steel in one embodiment of the present invention. The blade 22 may have a curved end 24. While a bump-shaped end 24 is shown in FIG. 1, other end designs may be utilized as well.

As the developer roll 14 rotates in the direction indicated by A, the uneven toner layer on the surface of the developer roll contacts the end 24 of the doctor blade 22 and is doctored off or squeezed into the nip between the end 24 and the roll 14, providing a uniform thickness toner layer on the output, clockwise, or downstream side of the doctor blade 22.

The doctor blade 22 may be supported in a spring biased configuration against the surface of the developer roll 14 through the application of a counterclockwise moment applied by a mounting bracket 27.

The mounting bracket 27 is coupled to the end 24 through a cantilever spring portion 25. The portion 25 provides a cantilever spring force biasing the end 24 against the developer roll 14.

Referring to FIG. 2, the doctor blade in its loaded position is shown. There it can be seen that the end 24 is formed by a first counterclockwise bend 28, a second clockwise bend 30 to a tip 32 which, in one embodiment, may be substantially aligned with the length of the portion 25. In one embodiment, the radius of curvature of the second bend is larger than the radius of curvature of the first bend. For example, the second bend radius of curvature may be between 0.2 mm and 1.4 mm and, more preferably, between 0.5 mm and 0.9 mm.

Referring back to FIG. 1, it can be seen that the blade 22 contacts the developer roll 14 at a point on bend 30. Further, as indicated in FIG. 1, the bend 30 defines a contact surface which is substantially tangential with the surface of the developer roll 14 as indicated by the tangent line T. Control of the second bend radius is critical to the proper function of this design.

Thus, it can be seen that the tip 32 of the blade 22 may be generally aligned with the axis of the developer roll 14. Moreover, the tip 32 does not contact the developer roll 14. Therefore, the orientation between the tip 32 and the developer roll 14 is less critical to operation of the doctor blade. Since the alignment between the end and the axis of the developer roll 14 may be difficult to control, in some embodiments, this critical parameter has been eliminated.

The doctor blade 22 may not require that the blade cantilever length be tightly controlled. Since this dimension is contained entirely within the doctor blade itself, it may not cause an assembly tolerance issue in some embodiments.

Moreover, the pressure of the blade 22 against the developer roll 14 is uniform along the length of the blade to avoid print defects. A flat doctor blade without the end 24 is not very stiff. Checkmark doctor blade designs tend to be 50 to 150 times stiffer than a flat blade. The blade shown in FIG. 1 may have a stiffness value of approximately 5 times larger than a flat blade, providing advantages, in some embodiments of the present invention, over the checkmark blade. Reducing stiffness may be important in manufacturing the part in that the straightness of the form is less critical and, thus, easier to manufacture with a conforming blade.

The first bend 28 allows the blade to operate in a position that is essentially tangent to the developer roll 14, unlike a checkmark blade that operates at an acute angle to the developer roll 14. The tangential orientation of the blade 22 reduces the blade stiffness in the radial direction for a given beam length, thickness, and modulus of elasticity. Uniform contact pressure between the doctor blade and the developer roll is critical to print quality. This can be achieved by minimizing the cross-sectional area moment of inertia of the doctor blade which, in turn, reduces the longitudinal stiffness of the blade. This allows the blade to conform to the surface of the developer roller and minimizes sensitivity to longitudinal part straightness. This feature results in a more robust design.

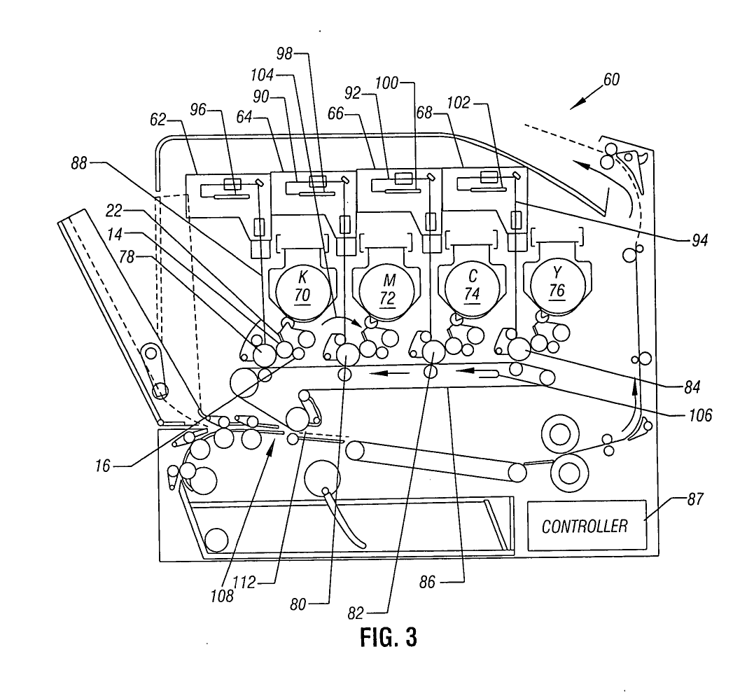

Referring to FIG. 3, there is shown one embodiment of an electro-photographic device 60 in which embodiments of the present invention may be applied. Of course the present invention is in no way limited to any specific printer design and may be applicable to a variety of different printer arrangements.

The device 60 includes laser print heads 62, 64, 66, and 68, a black toner cartridge 70, a magenta toner cartridge 72, a cyan toner cartridge 74, a yellow toner cartridge 76, photoconductive drums 78, 80, 82, and 84, an intermediate transfer belt 86, and a controller 87. In one embodiment, the controller may be a combination of application specific integrated circuits, microprocessors, and firmware suited to the tasks of printing documents.

Each of the laser print heads 62, 64, 66, and 68 projects a respective laser beam 88, 90, 92, and 94 off a respective one of the polygonal mirrors 96, 98, 100, and 102. As each of the polygonal mirrors 96, 98, 100, and 102 rotates, it scans a respective one of the reflected beams 88, 90, 92, and 94 in a scan direction, perpendicular to the plane of FIG. 3, across a respective one of the photoconductive drums 78, 80, 82, and 84.

Each of the photoconductive drums 78, 80, 82, and 84 may be negatively charged, for example, to approximately −1000 volts, and is subsequently discharged to a lower level, such as approximately −300 volts, in the areas of the peripheral surface that are impinged by a respective one of the laser beams 88, 90, 92, and 94.

During each scan of a laser beam across the photoconductive drum, each photoconductive drum 78, 80, 82, and 84 is continuously rotated, for example, in a clockwise direction, in a process direction indicated by the arrow 104. The scanning of the laser beams 88, 90, 92, and 94 across the peripheral surface of the photoconductive drums is cyclically repeated, thereby discharging the areas of the peripheral surfaces on which the laser beams impinge.

The toner in each of the toner cartridges 70, 72, 74, and 76 is negatively charged and is transported upon the surface of a developer roll 14 and biased, for example, to approximately −600 volts. Thus, when the toner for the cartridges 70, 72, 74, and 76 is brought into contact with the respective one of the photoconductive drums 78, 80, 82, and 84, the toner is attracted to and adheres to the portions of the peripheral surfaces of the drums that have been discharged to the lower voltage, say −300 volts, by the laser beams.

A doctor blade 22 may be associated with each toner cartridge 70, 72, 74, and 76. Particularly, a doctor blade 22 may be associated with each developer roll 14 which, in turn, is associated with a toner adder roll 16 and a photoconductor drum 78, 80, 82, or 84.

As the belt 86 rotates in the direction indicated by the arrow 106, the toner from each of the drums 78, 80, 82, and 84 is transferred to the outside surface of the belt 86. As a print medium, such as paper, travels along the path 108, the toner is transferred to the surface of the print medium at nip 112.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
forming a doctor blade with a curved end portion that intersects a developer roll along a tangent.

2. The method of claim 1 including forming a doctor blade with a straight section, a first bend in a first direction and a second bend in a second direction.

3. The method of claim 2 including mounting said doctor blade so that said second bend impacts a developer roll.

4. The method of claim 3 including securing said doctor blade so that said second bend includes a surface tangential to the surface of said developer roll.

5. A doctor blade comprising:
a mounting bracket; and
a cantilever spring coupled to said bracket, said spring including a straight section and a free end having a first bend from said straight section and a second bend after said first bend, said first and second bends being in opposite directions.

6. The blade of claim 5 wherein said free end includes a tip, said tip generally aligned with said straight section.

7. The blade of claim 5 wherein said second bend has a larger radius of curvature than said first bend.

8. The blade of claim 5 wherein said second bend radius is between 0.2 mm and 1.4 mm.

9. The blade of claim 5 made of stainless steel.

10. The blade of claim 5 where the region of said spring proximate to said second bend is curved.

11. The blade of claim 5 wherein said free end is bump shaped.

12. A printer comprising:
a developer roll; and
a doctor blade biased against said developer roll, said doctor blade including a curved end portion that intersects the developer roll along a tangent to said developer roll.

13. The printer of claim 12, said doctor blade including a mounting bracket and a cantilever spring coupled to said bracket, said spring including a straight section and a free end having a first bend from said straight section and a second bend after said first bend, said first and second bends being in opposite directions.

14. The printer of claim 13 wherein said free end includes a tip, said tip generally aligned with said straight section.

15. The printer of claim 13 wherein said second bend has a larger radius of curvature than said first bend.

16. The blade of claim 13 wherein said second bend radius is between 0.2 mm and 1.4 mm.

17. The printer of claim 12, said blade made of stainless steel.

18. The printer of claim 13 where the region of said blade proximate to said second bend is curved.

19. The printer of claim 13 wherein the free end includes a tip aligned with an axis of rotation of said developer roll.

20. The printer of claim 12 wherein said printer is a laser printer.
